(19) United States
(12) Patent Application Publication
(10) Pub. No.: US 2021/0058814 A1
(43) Pub. Date: Feb. 25, 2021

(54) METHODS AND SYSTEMS FOR PROCESSING TRAFFIC DATA FROM VEHICLES

(71) Applicant: Toyota Motor Engineering & Manufacturing North America, Inc., Plano, TX (US)

(72) Inventors: Aniruddh G. Puranic, Los Angeles, CA (US); Akihito Nakamura, Toyota (JP); BaekGyu Kim, Cupertino, CA (US)

(73) Assignee: Toyota Motor Engineering & Manufacturing North America, Inc., Plano, TX (US)

(21) Appl. No.: 16/548,221

(22) Filed: Aug. 22, 2019

(51) Int. Cl. H04W 28/02; H04W 28/06; H04W 4/40; H04W 4/20

(52) U.S. Cl. CPC H04W 28/021; H04W 28/06; H04W 4/20; H04W 28/0268; H04W 4/40

(57) ABSTRACT

A controller for processing traffic data from vehicles is provided. The controller includes one or more processors, one or more memory modules, and machine readable instructions stored in the one or more memory modules that, when executed by the one or more processors, cause the controller to: receive raw data from a plurality of vehicles on a road; determine information about the road; select a data reduction metric among a plurality of data reduction metrics based on the information about the road; and obtain reduced data for the plurality of vehicles, the raw data being transformed to the reduced data based on the selected data reduction metric.

### TECHNICAL FIELD

The present specification relates to processing traffic data from a plurality of vehicles, and more particularly, to reducing traffic data from a plurality of vehicles using a data reduction metric selected among a plurality of data reduction metrics based on information about a road on which the plurality of vehicles are driving.

### BACKGROUND

Connected vehicles generate large volumes of data (e.g., kinematics data such as speed, direction, and accelerations/decelerations, and sensory data such as steering angle and input acceleration pedal force) that need to be processed to extract useful information and produce results or predictions in real-time by utilizing the capabilities of edge computing. Edge computing is a distributed computing paradigm in which most of the computations are performed on distributed devices called edges, edge servers, edge computing devices, or nodes (e.g., smartphones, IoT devices, connected vehicles, traffic lights, cameras, etc.). Edge computing brings the power of memory and computation near the locations where it is needed and is characterized by low latency and reduced transmission costs to a centralized cloud while improving Quality of Service (QoS).

However, the memory and computation capabilities of edge servers may be inferior to those of centralized cloud servers. Transmitting and processing a large volume of data from multiple vehicles to one or more edge servers requires a large amount of storage, which may be limited in such edge servers. In addition, monitoring traffic and identifying anomalies may become computationally intensive on the edge servers when processing high-dimensional data (e.g., time-series data).

Accordingly, a need exists for providing a method and system that select an appropriate date reduction metric by analyzing traffic information and dynamically reducing raw data based on the selected data reduction metric.

### SUMMARY

A traffic anomaly is an irregularity or deviation from normal traffic patterns that cause disruptions to free traffic flow. Examples of a traffic anomaly include traffic congestions, accidents or collisions, unusual stoppages of vehicles, and the like. Drivers and vehicles affected by an anomaly may experience wasted time and fuel until the incident is resolved or cleared for normal traffic. When an accident occurs, it may take a long time for the appropriate authorities or other parties to receive an alert about the accident and/or for the authorities to take action. In order to perform automatic traffic monitoring and detection of abnormalities, large amounts of high-dimensional data (e.g., trajectory information, sensor and actuator information, etc.) generated by vehicles need to be transmitted to the edge or cloud servers and analyzed in real time.

Reducing the size of the traffic data may be important to process information faster and deliver correct results in real-time. While there are several data reduction metrics, each of them cannot be applied universally for all possible traffic scenarios because of their inherent characteristics. For example, traffic characteristics on a highway are substantially different from traffic characteristics on an intersection or at a residential area. The present disclosure provides systems and methods for intelligently selecting an appropriate data reduction metric that addresses the above identified issues, and which overcomes the difficulties of transmission and processing of large amount of data via edge servers.

In one embodiment, a controller for processing traffic data from vehicles is provided. The controller includes one or more processors, one or more memory modules, and machine readable instructions stored in the one or more memory modules that, when executed by the one or more processors, cause the controller to: receive raw data from a plurality of vehicles on a road; determine information about the road; select a data reduction metric among a plurality of data reduction metrics based on the information about the road; and obtain reduced data for the plurality of vehicles, the raw data being transformed to the reduced data based on the selected data reduction metric.

In another embodiment, a method for processing data from vehicles is provided. The method includes receiving raw data from a plurality of vehicles on a road, determining information about the road, selecting a data reduction metric among a plurality of data reduction metrics based on the information about the road, and obtaining reduced data for the plurality of vehicles, the raw data being transformed to the reduced data based on the selected data reduction metric.

In yet another embodiment, a system for reducing data from vehicles is provided. The system includes a plurality of vehicles on a road, and an edge computing device. The edge computing device includes one or more processors, one or more memory modules, and machine readable instructions stored in the one or more memory modules that, when executed by the one or more processors, cause the edge computing device to: determine information about the road, select a data reduction metric among a plurality of data reduction metrics based on the information about the road, transmit the selected data reduction metric to the plurality of vehicles, and receive reduced data from the plurality of vehicles, the reduced data being transformed using the selected data reduction metric.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for reducing the size of data collected from a plurality of vehicles using a data reduction metric, according to one or more embodiments shown and described herein;

FIG. 2 depicts a schematic diagram of the system for reducing the size of data collected from a plurality of vehicles using a data reduction metric, in accordance with one or more embodiments shown and described herein;

FIG. 3 schematically depicts reducing raw data using a data reduction metric, in accordance with one or more embodiments shown and described herein;

FIG. 4 depicts an operational sequence of obtaining reduced data for traffic monitoring, according to one or more embodiments shown and described herein;

FIG. 5 depicts a flowchart for reducing vehicle data, according one or more embodiments shown and described herein;

FIG. 6A depicts raw velocity-time data from a plurality of vehicles traveling on a highway, according one or more embodiments shown and described herein;

FIG. 6B depicts raw velocity-time data from a plurality of vehicles traveling on a highway and a mean value of the data, according one or more embodiments shown and described herein; and

FIG. 7 depicts dimensional points each indicating a similarity between a reference trajectory and the data trajectories for graphs in FIG. 6B, according one or more embodiments shown and described herein.

### DETAILED DESCRIPTION

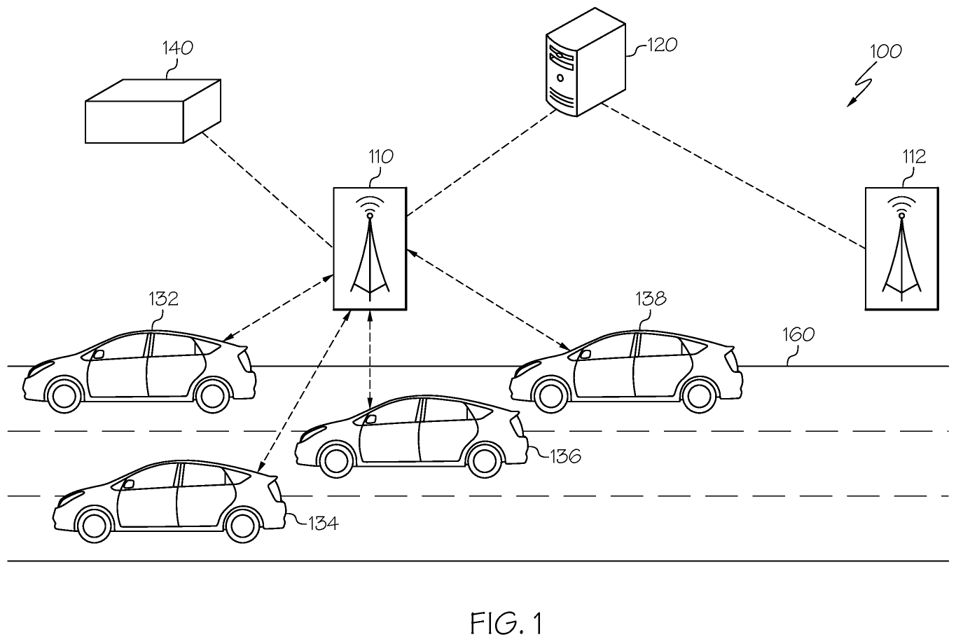

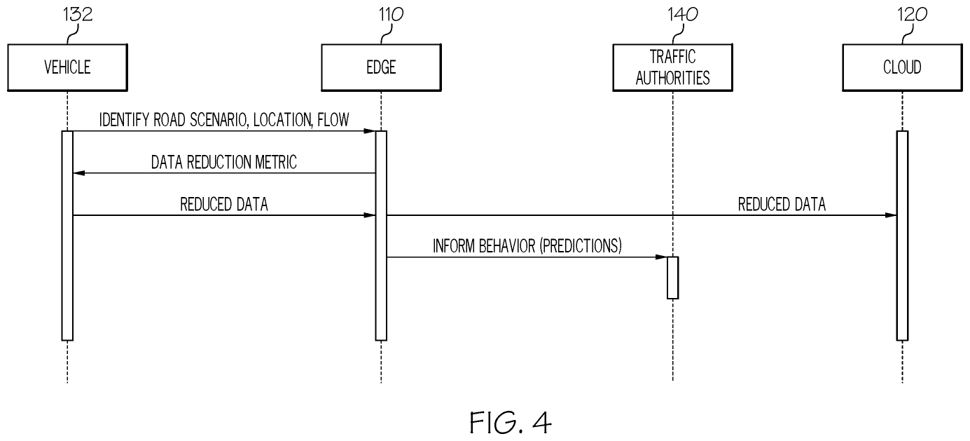

The embodiments disclosed herein include systems and methods for processing and reducing traffic data from vehicles. Referring to FIGS. 1 and 4, an edge computing device 110 receives raw data from a plurality of vehicles 132, 134, 136, 138 on a road 160. The edge computing device 110 determines information about the road 160, for example, a type of the road (e.g., a highway, an intersection, a residential road, a roundabout, a ramp, a one way road, and the like), a real-time traffic pattern of the road (e.g., speeds, accelerations, declarations, and lane changing behavior of vehicles), a regulations related to the road (e.g., a speed limit, whether the road is a one-way road, whether a stop sign is located on the road, and the like), how many lanes the road includes, and the like. The edge computing device 110 selects a data reduction metric among a plurality of data reduction metrics based on the information about the road 160. The edge computing device 110 transmits the selected data reduction metric to the plurality of vehicles 132, 134, 136, and 138. Each of the vehicles 132, 134, 136, and 138 applies the selected data reduction metric to the traffic data to obtain reduced data, and transmits the reduced data to the edge computing device 110.

The present disclosure automatically chooses an appropriate data reduction metric based on information about a road such as a road type and traffic flow information, such that the system of the present disclosure significantly reduces raw data without having to involve a large number of transmissions and operations of remote cloud servers. In addition, the reduced data according to the present disclosure maintains the characteristics of the raw data generated by vehicles for processing by the edge servers.

In contrast with conventional technologies, the present disclosure takes into consideration the information about a road such as a road type, which facilitates making intelligent decisions in choosing appropriate data reduction metrics that reduce data size remarkably for transmissions and provide an accurate representation of the data. The present disclosure enables real-time traffic monitoring with low latency because vehicle raw data is reduced using an appropriate data reduction metric at an edge computing device level.

FIG. 1 schematically depicts a system for reducing the size of data collected from a plurality of vehicles using a data reduction metric, according to one or more embodiments shown and described herein.

A system 100 includes a plurality of edge computing devices 110 and 112, a cloud server 120, a plurality of vehicles 132, 134, 136, and 138, and an authority 140. The edge computing device 110 is communicatively coupled to the cloud server 120 and the plurality of vehicles 132, 134, 136, and 138. The cloud server 120 may be deployed in a cloud computing system, and may manage the plurality of edge computing devices 110 and 112.

The edge computing device 110 may receive raw traffic data from the plurality of vehicles 132, 134, 136, and 138. The raw traffic data may include, but is not limited to, positions, orientations, speeds, accelerations, fuel consumptions, emissions, lane information, steering angles, input acceleration pedal forces, input braking forces, and the like. In embodiments, the edge computing device 110 may determine information about a road, such as road topology (e.g., highways, intersections, ramps, or the like), based on the raw traffic data. In some embodiments, the edge computing device 110 may store pre-assigned road topology based on the location of the edge computing device 110. For example, if the edge computing device 110 is located at the side of a highway, the edge computing device 110 may store the road topology as a highway. The edge computing device 110 may communicate with other edge computing devices, e.g., the edge computing device 112 via a network. The edge computing device 110 may be a fixed edge server, e.g., a road-side unit. In some embodiment, the edge computing device 110 may be a moving edge server, e.g., one of the vehicles on the road 160.

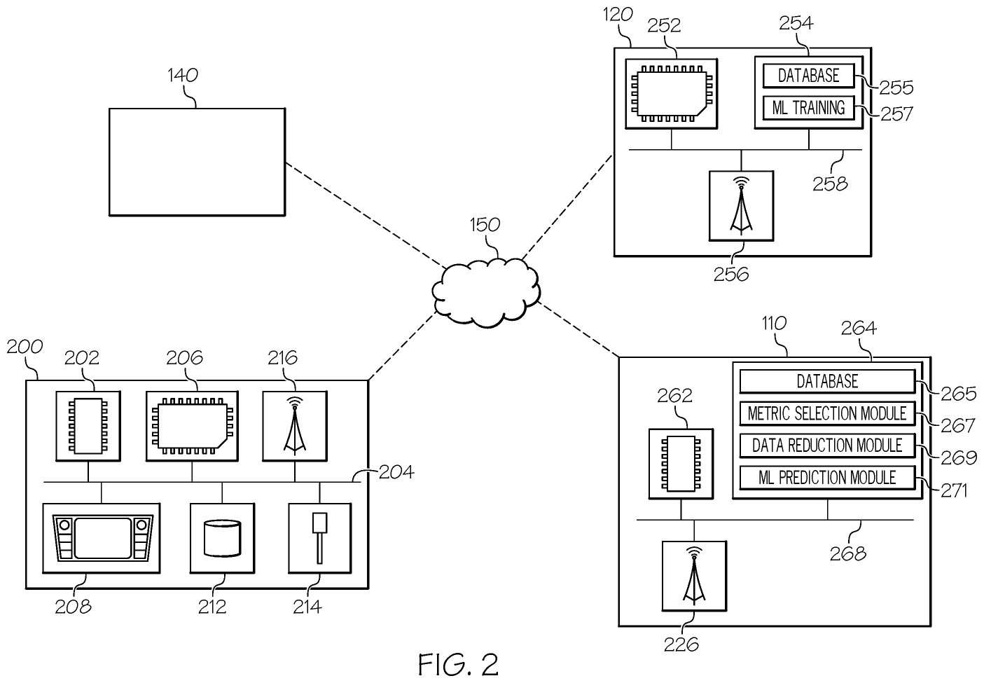

The edge computing device 110 may store a plurality of data reduction metrics, which will be described in detail below with reference to FIG. 2. The edge computing device 110 may select a data reduction metric among the plurality of data reduction metrics based on the information about the road 160. The information about the road 160 may include a type of the road (e.g., a highway, an intersection, a residential road, a roundabout, a ramp, a one way road, and the like), a real-time traffic pattern of the road, a regulations related to the road (e.g., a speed limit, whether the road is a one-way road, whether a stop sign is located on the road, and the like), how many lanes the road has, and the like.

In embodiments, the edge computing device 110 may transmit the selected data reduction metric to each of the plurality of vehicles 132, 134, 136, and 138. Each of the plurality of vehicles 132, 134, 136, and 138 may reduce their traffic data using the received data reduction metric and transmit reduced data to the edge computing device 110 according to the data reduction metric. In some embodiments, the edge computing device 110 may reduce traffic data received from the plurality of vehicles 132, 134, 136, and 138 using the selected data reduction metric.

The edge computing device 110 may transmit reduced traffic data to the cloud server 120, or the edge computing device 112. The edge computing device 110 may also analyze the reduced traffic data and inform the authority 140 of any abnormality in the analyzed traffic data. Because the edge computing device 110 analyzes reduced traffic data instead of raw data, which is much larger than the reduced traffic data, the analysis of the traffic data may be completed much faster than conventional technologies.

By still referring to FIG. 1, the plurality of vehicles 132, 134, 136, and 138 follow a road 160. Each of the vehicles 132, 134, 136, and 138 may be a vehicle including an automobile or any other passenger or non-passenger vehicle such as, for example, a terrestrial, aquatic, and/or airborne vehicle. In some embodiments, the vehicle is an autonomous vehicle that navigates its environment with limited human input or without human input. In another embodiment, the vehicle may be an unmanned aerial vehicle (UAV), commonly known as a drone. Each of the vehicles 132, 134, 136, and 138 may obtain traffic data including positions, orientations, speeds, accelerations, fuel consumptions, emissions, lane information, input acceleration pedal forces, input braking forces, and the like, using various vehicle sensors and transmit the traffic data to the edge computing device 110.

FIG. 2 depicts a schematic diagram of the system for reducing the size of data collected from a plurality of vehicles using a data reduction metric, in accordance with one or more embodiments shown and described herein. It is noted that, while the vehicle system 200 is depicted in isolation, the vehicle system 200 may be included within a vehicle in some embodiments, for example, within each of the plurality of vehicles 132, 134, 136, and 138 of FIG. 1. In embodiments in which the vehicle system 200 is included within a vehicle, the vehicle may be an automobile or any other passenger or non-passenger vehicle such as, for example, a terrestrial, aquatic, and/or airborne vehicle. In some embodiments, the vehicle is an autonomous vehicle that navigates its environment with limited human input or without human input.

The vehicle system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In some embodiments, the one or more memory modules 206 may include a plurality of data reduction metrics, and the one or more processors 202 may select an appropriate data reduction metric among the plurality of data reduction metrics based on information about the road on which a vehicle is currently traveling.

Referring still to FIG. 2, the vehicle system 200 comprises a screen 208 for providing visual output such as, for example, maps, navigation, entertainment, or a combination thereof. The screen 208 may output one of map, navigation, and entertainment. The screen 208 may output a location of a vehicle that behaves anomaly in response to receiving the location of the vehicle from the edge computing device 110 or the cloud server 120. The screen 208 is coupled to the communication path 204. Accordingly, the communication path 204 communicatively couples the screen 208 to other modules of the vehicle system 200 including, without limitation, the one or more processors 202 and/or the one or more memory modules 206. In embodiments, the screen 208 may be a touchscreen that, in addition to visually displaying information, detects the presence and location of a tactile input upon a surface of or adjacent to the screen 208. For example, a driver or occupant of the vehicle may input a current traffic information request through the screen 208. Accordingly, each display may receive mechanical (e.g., touch) input directly upon the optical output provided by the screen 208.

The vehicle system 200 comprises a satellite antenna 214 coupled to the communication path 204 such that the communication path 204 communicatively couples the satellite antenna 214 to other modules of the vehicle system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202. Based on the location, the vehicle system 200 may determine a type of the road on which the vehicle is currently traveling. For example, the vehicle system 200 may match the location of the vehicle with a map that including information about roads and determines the type of the road.

The vehicle system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring motion and changes in motion of the vehicle. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle. The one or more vehicle sensors 212 may include a fuel sensor that measures the level of fuel of the vehicle. The one or more vehicle sensors 212 may also include one or more sensors for detecting the angle of a steering wheel of a vehicle, one or more sensors for detecting an acceleration pedal force, and one or more sensors for detecting a braking force.

Still referring to FIG. 2, the vehicle system 200 comprises network interface hardware 216 for communicatively coupling the vehicle system 200 to the cloud server 120. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the vehicle system 200 may transmit its service request along with its route to the cloud server 120.

Still referring to FIG. 2, the vehicle system 200 may be communicatively coupled to the edge computing device 110, the cloud server 120, and the authority 140 by a network 150. In one embodiment, the network 150 may include one or more computer networks (e.g., a personal area network, a local area network, or a wide area network), cellular networks, satellite networks and/or a global positioning system and combinations thereof. Accordingly, the vehicle system 200 can be communicatively coupled to the network 150 via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

The edge computing device 110 includes one or more processors 262, one or more memory modules 264, network interface hardware 266, and a communication path 268. The one or more processors 262 may be a controller, an integrated circuit, a microchip, a computer, or any other computing device. The one or more memory modules 264 may comprise RAM, ROM, flash memories, hard drives, or any device capable of storing machine readable and executable instructions such that the machine readable and executable instructions can be accessed by the one or more processors 262.

The one or more memory modules 264 include a database 265, a metric selection module 267, a data reduction module 269, and a machine learning (ML) prediction module 271. Each of the database 265, the metric selection module 267, the data reduction module 269, and the ML prediction module 271 may be a program module in the form of operating systems, application program modules, and other program modules stored in one or more memory modules 264. In some embodiments, the program module may be stored in a remote storage device that may communicate with the edge computing device 110. In some embodiments, one or more of the database 265, the metric selection module 267, the data reduction module 269, and the ML prediction module 271 may be stored in the one or more memory modules 206 of the vehicle system 200. Such a program module may include, but is not limited to, routines, subroutines, programs, objects, components, data structures, and the like for performing specific tasks or executing specific data types as will be described below.

The database 265 may temporarily store raw traffic data received from a plurality of vehicles, e.g., vehicles 132, 134, 136, and 138 in FIG. 1. The database 265 may also include a plurality of data reduction metrics. The plurality of data reduction metrics include two categories: magnitude-based data reduction metrics and direction-based data reduction metrics. The magnitude-based data reduction metrics may include, but are not limited to, a dynamic time warping (DTW) metric, a Mahalanobis metric, an Euclidean metric, a Chebyshev metric, and a

Manhattan metric. The DTW metric is a dynamic programming-based algorithm for measuring a similarity between two temporal sequences or vectors. The Mehalanobis metric is a measure of a distance between a point and a distribution. The Mehalanobis metric is a multi-dimensional generalization of the idea of measuring how may standard deviations the point is from the mean of the deviation. The Euclidian metric is a Pythagorean distance between two vectors in Euclidean space, or in Cartesian coordinates. The Chebyshev metric, also known as a maximum metric, is defined as the largest distance between any two vectors along any dimension. The Manhattan metric, also known as a taxi-cab distance, is the sum of the absolute differences between two vectors in Cartesian coordinates.

The direction-based data reduction metrics may include, but are not limited to, a Cosine metric and a Pearson Correlation Coefficient (PCC) metric. The Cosine metric is a measure of similarity between two vectors that measures the cosine of the angle between the two vectors. The PCC metric is a bivariate correlation that measures the linear relationship between two vectors.

The metric selection module 267 is configured to retrieve and analyze the raw data in the database 265 to select an appropriate data reduction metric based on the analyzed raw data. The metric selection module 267 may distinguish between the patterns that frequently change and the patterns that remain similar over time, and, based on the distinction, the metric selection module 267 may select an appropriate data reduction metric among a plurality of data reduction metrics. For example, the metric selection module 267 may select a magnitude-based data reduction metric or a direction-based data reduction metric based on the characteristics of raw traffic data received from a plurality of vehicles.

In embodiments, time-series data, such as the trajectories of the plurality of vehicles, may be represented as vectors with the number of dimensions being the timestamps recorded. A vector in mathematics is a geometric entity that is characterized by having a magnitude and a direction. For example, in the vector representation of a velocity-time trajectory of a vehicle, at each time instant, the magnitude of the vector consists of the actual speed (e.g., 30 mile per hour) and the direction component of the vector represents whether this speed is increasing or decreasing. The magnitude indicates how large or small a particular entity is, while the direction represents a trend (i.e., changes or fluctuations in the value of the entity) in the time-series data. By referring to FIG. 1, if the road 160 is a highway, the metric selection module 267 may determine that the traffic data from the plurality of vehicles, e.g., vehicles 132, 134, 136, and 168, exhibit rational behaviors (such as following speed limits and smooth lane changing behaviors). Therefore, the direction of the vectors for the plurality of vehicles, i.e., an increase or decrease in the magnitude, is a significant contributor to the traffic behavior. Thus, the metric selection module 267 may select a data reduction metric related to a direction. For example, the metric selection module 267 may select one of the Cosine metric and the Pearson Correlation Coefficient (PCC) metric.

On the other hand, when vehicles are at intersections and residential areas, a lot of lane changing behaviors and frequent accelerations and decelerations by vehicles may be expected. Hence, the magnitude of vectors is of enhanced relative importance in this situation. Thus, the metric selection module 267 may select a data reduction metric related to a magnitude. For example, the metric selection module 267 may select one of the DTW metric, the Mahalanobis, the Euclidean metric, the Chebyshev metric, and the Manhattan metric.

Accordingly, the metric selection module 267 may select the most appropriate data reduction method that ensures both the amount of the data reduction and the quality of the reduced data. Based on the road types and traffic flow information perceived by the edge computing device 110 and the vehicles, the metric selection module 267 chooses the appropriate data reduction metric.

Additionally, the metric selection module 267 may select a data reduction metric that not only reduces the size of raw data, but also preserves the characteristic of the raw data when it is decompressed. Thus, the metric selection module 267 identifies the patterns that frequently change in the raw data received from the plurality of vehicles, and applies the most appropriate reduction metric that works best for such a pattern.

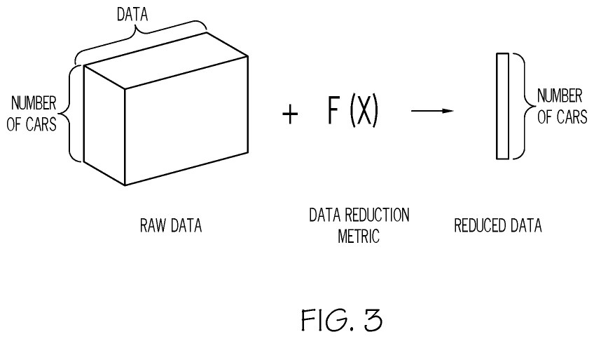

The data reduction module 269 is configured to perform data transformation and reduction of raw data. For example, as shown in FIG. 3, raw data from a plurality of vehicles are processed and reduced according to a selected data reduction metric. The one or more processors 262 may analyze the reduced data or send the reduced data to the cloud server 120 for more processing.

The ML prediction module 271 is configured to perform real-time prediction on the reduced data provided by the data reduction module 269 such as traffic monitoring, individual driver behavior monitoring, anomaly detection, and the like.

Still referring to FIG. 2, the cloud server 120 includes one or more processors 252, one or more memory modules 254, network interface hardware 256, and a communication path 258. The one or more processors 252 may be a controller, an integrated circuit, a microchip, a computer, or any other computing device. The one or more memory modules 254 may comprise RAM, ROM, flash memories, hard drives, or any device capable of storing machine readable and executable instructions such that the machine readable and executable instructions can be accessed by the one or more processors 252. The network interface hardware 256 communicates with the edge computing device 110 and the vehicle system 200.

The one or more memory modules 254 include a database 255, and a machine learning (ML) training module 257. Each of the database 255 and the ML training module 257 may be a program module in the form of operating systems, application program modules, and other program modules stored in one or more memory modules 254. In some embodiments, the program module may be stored in a remote storage device that may communicate with the cloud server 120. Such a program module may include, but is not limited to, routines, subroutines, programs, objects, components, data structures, and the like for performing specific tasks or executing specific data types as will be described below.

The database 255 may store the reduced data from the edge computing device 110. The ML training module 257 may perform create models for optimizing system performance and send the learned models to the edge computing device 110 to produce real-time predictions.

FIG. 4 depicts an operational sequence of obtaining reduced data for traffic monitoring, according to one or more embodiments shown and described herein.

In embodiments, the vehicle 132 may identify the type of a road on which the vehicle 132 is driving using a location sensor such as the satellite antenna 214 and transmit information about the type of the road to the edge computing device 110. The type of a road may include, but not limited to, a highway, an intersection, a residential road, a roundabout, a ramp, one way road, and the like. For example, the vehicle 132 may identify the location of the vehicle 132 using the satellite antenna 214 and identify the type of the road on which the vehicle 132 is driving as a highway based on the location of the vehicle 132 on a map including information about roads. As another example, the vehicle 132 may identify the location of the vehicle 132, and identify the type of the road on which the vehicle 132 is driving as an intersection.

In some embodiments, the vehicle 132 may transmit information related to traffic flow to the edge computing device 110. For example, the vehicle 132 may transmit the speed, acceleration, deceleration, or orientation of the vehicle to the edge computing device 110. The edge computing device 110 may collect information about traffic flow from a plurality of vehicles.

The edge computing device 110 then may select an appropriate data reduction metric among a plurality of data reduction metrics based on the information about the type of road, the location of the vehicle, and/or the traffic flow information. For example, as discussed above, if the information about the type of road indicates a highway, the edge computing device 110 may select a direction-based data reduction metric. If the information about the type of road indicates an intersection, the edge computing device 110 may select a magnitude-based data reduction metric. As another example, if the traffic information collected from a plurality of vehicles indicates a lot of lane changing behaviors and frequent accelerations and decelerations by vehicles, the edge computing device 110 may select a magnitude-based data reduction metric. If the traffic information collected from a plurality of vehicles indicates smooth lane changing behaviors and few accelerations and declarations, the edge computing device 110 may select a direction-based data reduction metric.

Then, the edge computing device 110 may transmit the selected data reduction metric to the vehicle 132. The vehicle 132 may reduce its raw data by applying the selected data reduction metric to the raw data, and transmit the reduced data to the edge computing device 110.

The reduced data may accurately represent the original data in a low-dimensional format. The edge computing device 110 may process the reduced data to monitor traffic behavior on the road in real-time and alert entities, such as traffic authorities, if unusual traffic behavior is identified. The edge computing device 110 may also transmit an alert to a vehicle in the vicinity or update navigation applications. In response, the vehicle may display an alert or the location of the vehicle showing usual traffic behavior. The edge computing device 110 may periodically transmit the reduced data to the cloud server 120. The cloud server 120 may collect the reduced data and implement machine learning from the collected data to optimize and improve prediction models and overall system performance which is not time-dependent.

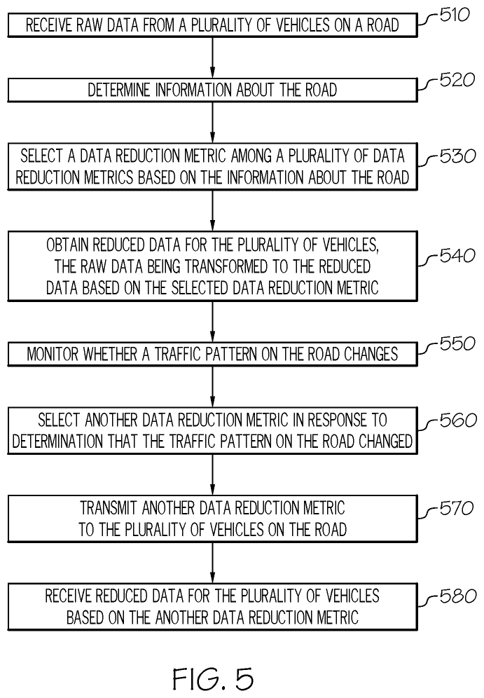

FIG. 5 depicts a flowchart for reducing vehicle data, according one or more embodiments shown and described herein.

In step 510, the edge computing device 110 may receive raw data from a plurality of vehicles on a road and/or a plurality of road side units. For example, as shown in FIG. 1, the edge computing device 110 may receive raw data from a plurality of vehicles 132, 134, 136, and 138. The raw data may include kinematics data, sensor data, and actuator data. The kinematics data may include information about X-vs-time, Y-vs-time, angle, X-vs-Y trajectory, velocity-time, and acceleration-time. The sensor data may include videos and/or images captured by imaging devices of the vehicles and/or the road side units, fuel consumption information detected by fuel sensors, and/or emissions data determined by emission sensors. The actuator data may include information about a steering angle, an input acceleration pedal force, and an input braking force. The data collected from the plurality of vehicles 132, 134, 136, and 138 may be analyzed as vectors having magnitude and directions.

In step 520, the edge computing device 110 may determine information about the road. In embodiments, the edge computing device 110 may determine the type of the road based on locations of the plurality of vehicles. For example, by referring to FIG. 1, the edge computing device 110 may receive locations of the plurality of vehicles 132, 134, 136, and 138 and determine the type of road based on locations of the plurality of vehicles 132, 134, 136, and 138. In some embodiments, the edge computing device 110 may determine information about traffic flow of the road.

In step 530, the edge computing device 110 may select a data reduction metric among a plurality of data reduction metrics based on information about the road. The data reduction metric is a similarity measure on the vectorized representation of the data collected from the plurality of vehicles, such as vehicles, 132, 134, 136, and 138. The plurality of data reduction metrics include two categories: magnitude-based data reduction metrics and direction-based data reduction metrics. The magnitude-based data reduction metrics may include, but are not limited to, the dynamic time warping (DTW) metric, the Mahalanobis metric, the Euclidean metric, the Chebyshev metric, and the Manhattan metric. The direction-based data reduction metrics may include, but are not limited to, the Cosine metric and the Pearson Correlation Coefficient (PCC) metric.

The edge computing device 110 then may select an appropriate data reduction metric among a plurality of data reduction metrics based on the information about the type of road, the location of the vehicle, and/or the traffic flow information. For example, as discussed above, if the information about the type of road indicates a highway, the edge computing device 110 may select a direction-based data reduction metric. If the information about the type of road indicates an intersection, the edge computing device 110 may select a magnitude-based data reduction metric. As another example, if the traffic information collected from a plurality of vehicles indicates a lot of lane changing behaviors and frequent accelerations and decelerations by vehicles, the edge computing device 110 may select a magnitude-based data reduction metric. If the traffic information collected from a plurality of vehicles indicates smooth lane changing behaviors and few accelerations and declarations, the edge computing device 110 may select a direction-based data reduction metric. As another example, if the traffic information collected from a plurality of vehicles indicates circular movements by vehicles due to, e.g., a roundabout, the edge computing device 110 may select a magnitude-based data reduction metric. As another example, if the traffic information collected from a plurality of vehicles indicates frequent accelerations and decelerations by vehicles due to, e.g., a stop sign, the edge computing device 110 may select a magnitude-based data reduction metric.

In step 540, the edge computing device 110 obtains reduced data for the plurality of vehicles. In embodiments, the edge computing device may transmit the selected data reduction metric to the plurality of vehicles on the road, and receive the reduced data from the plurality of vehicles on the road in response to the plurality of vehicles receiving the selected data reduction metric, reducing raw data according to the selected data reduction metric, and transmitting the reduced data to the edge computing device 110. For example, the edge computing device 110 may select the DTW metric as a data reduction metric and transmit an indication that the DTW metric is selected to the plurality of vehicles 132, 134, 136, and 138. Each of the plurality of vehicles 132, 134, 136, and 138 may reduce its raw data by applying the DTW metric to their raw data. Then, each of the plurality of vehicles 132, 134, 136, and 138 may transmit the reduced raw data to the edge computing device 110. In some embodiments, the edge computing device 110 may receive raw data from the plurality of vehicles, and apply the DTW metric to the raw data to obtain reduced data.

In step 550, the edge computing device 110 monitors whether a traffic pattern on the road changes. For example, a plurality of vehicles may drive on a highway, and follow speed limits and have smooth lane changing behavior. When there is an accident or a construction on the highway, the traffic pattern on the highway changes such that a lot of lane changing behaviors and frequent accelerations and decelerations may be detected.

In step 560, the edge computing device 110 selects another data reduction metric in response to determination that the traffic pattern on the road changes. For example, in response to determination that the traffic pattern on the highway shows a lot of lane changing behaviors and frequent accelerations and decelerations due to, e.g., accidents or constructions, the edge computing device 110 selects a magnitude-based data reduction metric instead of a direction-based data reduction metric.

In step 570, the edge computing device 110 may transmit another data reduction metric to the plurality of vehicles on the road. For example, the edge computing device 110 may transmit a magnitude-based data reduction metric, e.g., the Euclidean metric, to the plurality of vehicles 132, 134, 136, and 138 on the highway having a construction site or an accident.

In step 580, the edge computing device receives reduced data from the plurality of vehicles on the road. For example, the edge computing device 110 may select the Euclidean metric as a data reduction metric and transmit an indication ghat the Euclidian metric is selected to the plurality of vehicles 132, 134, 136, and 138. Each of the plurality of vehicles 132, 134, 136, and 138 may reduce its raw data by applying the Euclidean metric to the raw data. Then, each of the plurality of vehicles 132, 134, 136, and 138 may transmit the reduced raw data to the edge computing device 110. In some embodiments, the edge computing device 110 may receive raw data from the plurality of vehicles, and apply the Euclidean metric to the raw data to obtain reduced data, instead of transmitting the Euclidean metric to each of the vehicles 132, 134, 136, and 138.

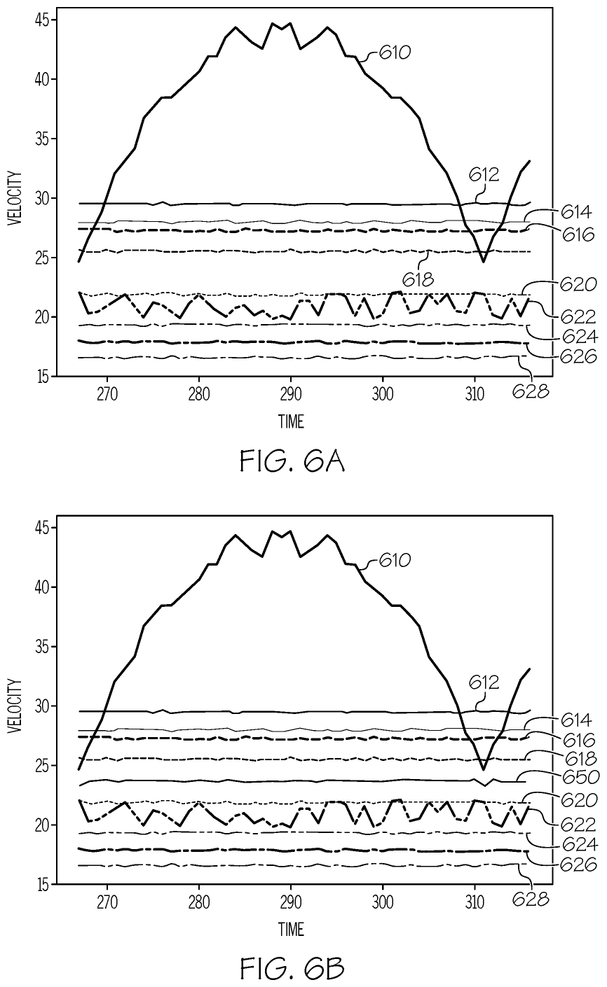

FIG. 6A depicts raw velocity-time data from a plurality of vehicles traveling on a highway. A plurality of graphs 610, 612, 614, 616, 618, 620, 622, 624, 626, and 628 depict velocities of a plurality of vehicles over time. The graph 610 depicts that a vehicle corresponding to the graph 610 exhibits excess-speeding behavior compared to other vehicles as shown by the graphs 612, 614, 616, 618, 620, 622, 624, 626, and 628 in FIG. 6A.

According to the present disclosure, the data representing the plurality of graphs is standardized to have a mean of 0 and standard deviation of 1. The variation or fluctuations in the data may be estimated by computing the range, standard deviation and variance-to-mean ratio. The edge computing device 110 may determine whether the fluctuations of the data are higher or lower than a threshold value, and dynamically choose a reduction data metric among a plurality of reduction data metrics based on the determination whether the fluctuations of the data are higher or lower than an average value. For example, if it is determined that the fluctuation of the data is higher than the threshold value, the edge computing device 110 may select a magnitude-based data reduction metric. If it is determined that the fluctuation of the data is lower than the threshold value, the edge computing device 110 may select a direction-based data reduction metric.

In FIG. 6A, the fluctuation of data is relative small, and thus smaller than a threshold value. Thus, a direction-based data reduction metric, for example, the direction-based cosine metric, may be selected. In order to compute similarity among the data, a reference trajectory may be first computed. For example, a median for the data may be used as the reference trajectory because a median is generally robust to noise and/or outliers. The graph 650 in FIG. 6B depicts a median value for the graphs 610, 612, 614, 616, 618, 620, 622, 624, 626, and 628. In some embodiments, a speed limit for the road may be used as the reference trajectory. For example, for a highway, a speed limit, e.g., 55 mile per hour, may be used as a reference trajectory in order to compute similarity among data for a plurality of vehicles traveling on the highway.

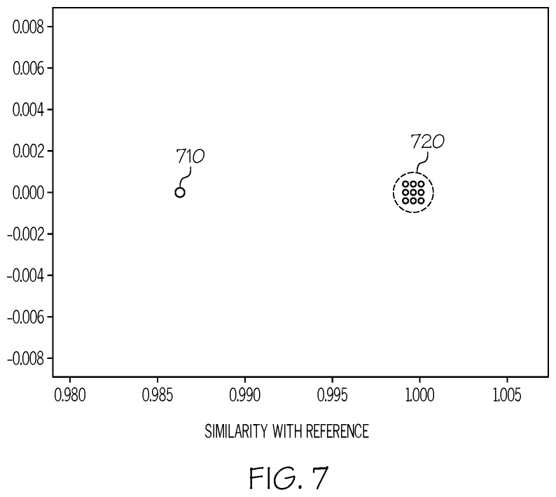

The similarity metric, e.g., cosine metric, is then applied for each data trajectory of the graphs 610, 612, 614, 616, 618, 620, 622, 624, 626, and 628 with the mean value of the graph 650 to obtain a dimensional point. FIG. 7 depicts 10 dimensional points that correspond to the data trajectory of the graphs 610, 612, 614, 616, 618, 620, 622, 624, 626, and 628, respectively. Each of the dimensional points represents the similarity between the reference trajectory and each of the data trajectory of the graphs 610, 612, 614, 616, 618, 620, 622, 624, 626, and 628. In FIG. 7, the dimensional point 710 indicates a similarity between the reference trajectory and the data trajectory for the graph 610. A group of the dimensional points 720 indicate similarities between the reference trajectory and the data trajectory for the graphs 612, 614, 616, 618, 620, 622, 624, 626, and 628. As shown in FIG. 7, the dimensional point 710 which corresponds to the misbehaving vehicle is clearly separated from the group of dimensional points 720. This shows that the characteristics of the original raw data are preserved even after the data is reduced using the selected data reduction metric.

It should be understood that embodiments described herein are directed to systems and methods for choosing an appropriate data reduction metric for reducing raw traffic data. The method includes receiving raw data from a plurality of vehicles on a road, determining information about the road, selecting a data reduction metric among a plurality of data reduction metrics based on the information about the road, and obtaining reduced data for the plurality of vehicles that are transformed based on the selected data reduction metric. The present disclosure automatically selects an appropriate data reduction metric based on information about a road such as a road type and traffic flow, and significantly reduces raw data generated by vehicles based on the selected data reduction metric without having to involve the large number of transmissions and operations of remote cloud servers.

In contrast with conventional technologies, the present disclosure takes into consideration real-time information about a road including a type of the road (e.g., a highway, an intersection, a residential road, a roundabout, a ramp, a one way road, and the like), a traffic pattern of the road (e.g., speeds, accelerations, declarations, and lane changing behavior of vehicles), regulations related to the road (e.g., a speed limit, whether the road is a one-way road, whether a stop sign is located on the road, and the like), how many lanes the road has, and the like. The consideration of information about a road facilitates making intelligent decisions in choosing appropriate data reduction metrics that reduce data size remarkably for transmissions and provides an accurate representation of the data. The present disclosure enables real-time monitoring traffic with low latency because vehicle raw data is reduced using an appropriate data reduction metric at an edge computing device level.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A controller for processing data from vehicles, the controller comprising:
one or more processors;
one or more memory modules; and
machine readable instructions stored in the one or more memory modules that, when executed by the one or more processors, cause the controller to:
receive raw data from a plurality of vehicles on a road;
determine information about the road;
select a data reduction metric among a plurality of data reduction metrics based on the information about the road; and
obtain reduced data for the plurality of vehicles, the raw data being transformed to the reduced data based on the selected data reduction metric.

2. The controller of claim 1, wherein the machine readable instructions stored in the one or more memory modules, when executed by the one or more processors, cause the controller to:
transmit the selected data reduction metric to the plurality of vehicles on the road; and
receive the reduced data from the plurality of vehicles on the road.

3. The controller of claim 1, wherein the machine readable instructions stored in the one or more memory modules, when executed by the one or more processors, cause the controller to:
determine whether a traffic pattern on the road changes;
select another data reduction metric in response to determination that the traffic pattern on the road has changed; and
obtain reduced data for the plurality of vehicles based on the another data reduction metric.

4. The controller of claim 1, wherein:
the information about the road includes a type of road; and
the machine readable instructions stored in the one or more memory modules, when executed by the one or more processors, cause the controller to determine the type of road based on locations of the plurality of vehicles.

5. The controller of claim 4, wherein the type of road includes a highway, an intersection, or a residential road.

6. The controller of claim 1, wherein the machine readable instructions stored in the one or more memory modules, when executed by the one or more processors, cause the controller to:
determine whether one of the reduced data deviates from other reduced data; and
transmit a notification to an authority in response to determination that one of the reduced raw data deviates from other reduced raw data.

7. The controller of claim 1, wherein the machine readable instructions stored in the one or more memory modules, when executed by the one or more processors, cause the controller to:
compute reference data based on the raw data from the plurality of vehicles; and
apply the determined data reduction metric to a pair of the reference data and each of the raw data from the plurality of vehicles.

8. The controller of claim 1, wherein the plurality of data reduction metrics include a magnitude based metric and a direction based metric.

9. The controller of claim 8, wherein:
the magnitude based metric includes at least one of a Dynamic Time Warping (DTW) metric, a Mahalanobis metric, an Euclidean metric, a Chebyshev metric, and a Manhattan metric; and
the direction based metric includes at least one of a Cosine metric and Pearson Correlation Coefficient (PCC) metric.

10. The controller of claim 8, wherein the machine readable instructions stored in the one or more memory modules, when executed by the one or more processors, cause the controller to:
determine that a type of the road is a highway; and
select the direction based metric in response to determination that the type of the road is the highway.

11. The controller of claim 8, wherein the machine readable instructions stored in the one or more memory modules, when executed by the one or more processors, cause the controller to:
determine that a type of the road is an intersection or a residential road; and
select the magnitude based metric in response to determination that the type of the road is the intersection or the residential road.

12. A method for processing data from vehicles, the method comprising:
receiving raw data from a plurality of vehicles on a road;
determining information about the road;
selecting a data reduction metric among a plurality of data reduction metrics based on the information about the road; and
obtaining reduced data for the plurality of vehicles, the raw data being transformed to the reduced data based on the selected data reduction metric.

13. The method of claim 12, further comprising:
transmitting the selected data reduction metric to the plurality of vehicles on the road; and
receiving the reduced data from the plurality of vehicles on the road.

14. The method of claim 12, further comprising:
monitoring whether a traffic pattern on the road changes;
selecting another data reduction metric in response to determination that the traffic pattern on the road changed;
transmitting the another data reduction metric to the plurality of vehicles on the road; and
receiving reduced data for the plurality of vehicles based on the another data reduction metric.

15. The method of claim 12, further comprising:
determining a type of road based on locations of the plurality of vehicles,
wherein the type of road includes a highway, an intersection, and a residential road.

16. The method of claim 12, further comprising:
determining whether one of the reduced data deviates from other reduced data; and
transmitting a notification to an authority in response to determination that one of the reduced raw data deviates from other reduced raw data.

17. The method of claim 12, wherein the plurality of data reduction metrics include a magnitude based metric and a direction based metric.

18. A system for reducing data from vehicles, the system comprising:
a plurality of vehicles on a road; and
an edge computing device comprising:
one or more processors;
one or more memory modules; and
machine readable instructions stored in the one or more memory modules that, when executed by the one or more processors, cause the edge computing device to:
determine information about the road;
select a data reduction metric among a plurality of data reduction metrics based on the information about the road;
transmit the selected data reduction metric to the plurality of vehicles; and
receive reduced data from the plurality of vehicles, the reduced data being transformed using the selected data reduction metric.

19. The system of claim 18, wherein the machine readable instructions stored in the one or more memory modules, when executed by the one or more processors, cause the edge computing device to:
determine whether a traffic pattern on the road changes;
select another data reduction metric in response to determination that the traffic pattern on the road has changed; and
obtain reduced data for the plurality of vehicles based on the another data reduction metric.

20. The system of claim 18, wherein the machine readable instructions stored in the one or more memory modules, when executed by the one or more processors, cause the edge computing device to:
determine whether one of the reduced data deviates from other reduced data; and
transmit a notification to an authority in response to determination that one of the reduced raw data deviates from other reduced raw data.
